(19) United States
(12) Patent Application Publication
(10) Pub. No.: US 2006/0102006 A1
(43) Pub. Date: May 18, 2006

(54) HVAC automatic air filter

(76) Inventor: Henry Jay Powell, Plano, TX (US)

Correspondence Address: Henry J. Powell, 9109 Roundbluff Road, Plano, TX, 75025, US

(21) Appl. No.: 10/987,392

(22) Filed: Nov. 12, 2004

(51) Int. Cl. B01D 46/00

(52) U.S. Cl. 96/429

(57) ABSTRACT

The object of this invention is an automatic air-filter changing system for use in light commercial and residential high-volume air conditioner (HVAC) systems. This invention uses a filter housing that connects to the air return portion of HVAC systems, either in-line (by splicing the air return duct) or as part of the heating/cooling coil structure. The filter housing contains a drive-motor and drive-motor control unit. Within the filter housing, a filter cartridge is placed. The filter cartridge comprises a supply container, a collection container, and filter material. The filter material is initially stored in the supply container of the filter cartridge. The drive-motor of the filter housing advances the filter material from the supply container of the filter cartridge to the collection container of the filter cartridge. The drive-motor control unit controls the frequency and length of filter material advancement. The drive-motor control unit is a programmable unit that supports human interface through a keypad and other devices (such as an LED display) as necessary to enable a person to program the unit. The drive-motor control unit is connected to the drive-motor and controls the frequency and length of filter material advancement by regulating the electrical current supplied to the drive-motor.

### CROSS-REFERENCE TO RELATED APPLICATIONS

No claims to benefits of prior applications are made under this Specification.

### STATEMENT REGARDING FEDERALLY SPONSORED RESEARCH OR DEVELOPMENT

This invention is not the result of federally sponsored research.

### REFERENCE TO SEQUENCE LISTING, A TABLE, OR A COMPUTER PROGRAM LISTING COMPACT DISK APPENDIX

None

### BACKGROUND OF THE INVENTION

1. Field of Invention

This invention relates to air filters used in light commercial and residential high-volume air conditioner (HVAC) systems. The present invention contains a motorized filter housing in which a filter cartridge is placed. The motorized housing automatically advances the filter material contained in the filter cartridge, resulting in an automatic air filter changing system.

The applicable U.S. patent Classification Definition for this invention includes, but is not limited to, class “55—Gas Separation,” subclasses “282—With non-liquid cleaning means for separating,” “283—With automatic control of cleaning means,” “351—With means for advancing clean portions of continuous or indefinite length separating media into gas stream,” and “527—Fibrous or strand form.” 55/282, 55/283, 55/351, and 55/527

2. Description of Related Art

Conventional HVAC system designs deploy air filters either at the air return registers, in-line within the air return duct or ducts, or at the heating/cooling coils. Air filters are a critical component to modern HVAC systems. Dirty, clogged filters restrict airflow to the system resulting in excess strain on the system, reduced efficiency, and could possibly shorten the mechanical life of the system. As such, HVAC equipment manufacturers recommend changing filters as frequently as every three to four weeks.

Conventional residential and light commercial-use HVAC systems employ a non-mechanized air filter manufactured in standard shapes and sizes. Introducing a clean air filter into the HVAC system requires removing the existing, non-mechanized filter, discarding the used filter, and installing a replacement filter. This process must be repeated periodically, preferably every four weeks according many HVAC manufacturers.

While replacing filters is not complicated, many consumers fail to do so and this failure results in increased energy consumption, poor heating/cooling quality, and increased maintenance and repair costs. Previous attempts to automate the replacement of HVAC air filters (such as U.S. Pat. No. 5,217,513) required manual intervention each time the filter required replacement.

### SUMMARY OF THE INVENTION

Accordingly, the object of this invention is a more automated HVAC air filter system—a self-changing air filter system.

The system is composed of a filter housing containing a drive-motor and motor controls and a filter cartridge containing a supply container and collection container. The filter housing may be installed in-line by splicing into the air return duct (the duct providing air to the heating/cooling coils). Additionally, the filter housing may be attached directly to the heating/cooling coil structure itself.

The filter housing contains a drive-motor attached to a shaft and gear. The drive-motor advances the filter material contained in the filter cartridge by a predetermined amount. The amount of material to advance is based on the size of the air return. Electrical power to the drive-motor may be supplied via the building's electrical system (hard-wired) or battery. For simplicity, a hard-wired connection is assumed in this document.

The filter housing also contains a motor control unit used to program the frequency and length of filter advancement by regulating the electrical current supplied to the drive-motor. The frequency setting of the control unit controls how often (hours, days, weeks, months, etc.) the filter material is advanced. The length setting of the control unit controls how much filter material to advance. For example, installation in a residential HVAC unit with a twenty-inch diameter air return duct could be programmed to advance twenty inches of filter every thirty days.

A filter cartridge, containing a supply container and a collection container, is placed within the filter housing. The filter material within the cartridge is advanced from the supply container (which contains clean filter material) to the collection container (which houses the used filter material) by the drive-motor of the filter housing. When the clean filter material is fully depleted, the entire filter cartridge is removed and discarded, and a new cartridge is installed.

### BRIEF DESCRIPTION OF THE SEVERAL VIEWS OF THE DRAWING

FIG. 1—Front view of the filter housing

FIG. 2—Top view of the filter housing

FIG. 3—Bottom view of the filter housing

FIG. 4—Back view of the filter housing

FIG. 5—Back, right angle view of filter housing

FIG. 6—Front, right angle view of filter housing

FIG. 7—Left, side view of filter housing

FIG. 8—Right, side view of filter housing

FIG. 9—Exploded, back, right angle view of filter housing showing housing lid removed from housing base

FIG. 10—Exploded view of filter cartridge

FIG. 11—Bottom view of filter cartridge

FIG. 12—Top view of filter cartridge

FIG. 13—Back view of filter cartridge

FIG. 14—Front view of filter cartridge

FIG. 15—Left, side view of filter cartridge

FIG. 16—Right, side view of filter cartridge

FIG. 17—Exploded view of filter housing and filter cartridge showing placement of cartridge within housing

FIG. 18—Top view of drive-motor

FIG. 19—Bottom view of drive-motor

FIG. 20—Front view of drive-motor

FIG. 21—Filter housing installed in-line

FIG. 22—Filter housing installed as part of coil structure

FIG. 23—Drive-Motor Control Connection to Drive-Motor

### DETAILED DESCRIPTION OF THE INVENTION

Preferred embodiments of the present invention will be described hereinafter with reference to the accompanying drawings.

Referring now to the drawings, there are disclosed preferred embodiments of the present invention. In referring to the figures of the drawings, like numerals shall refer to like parts.

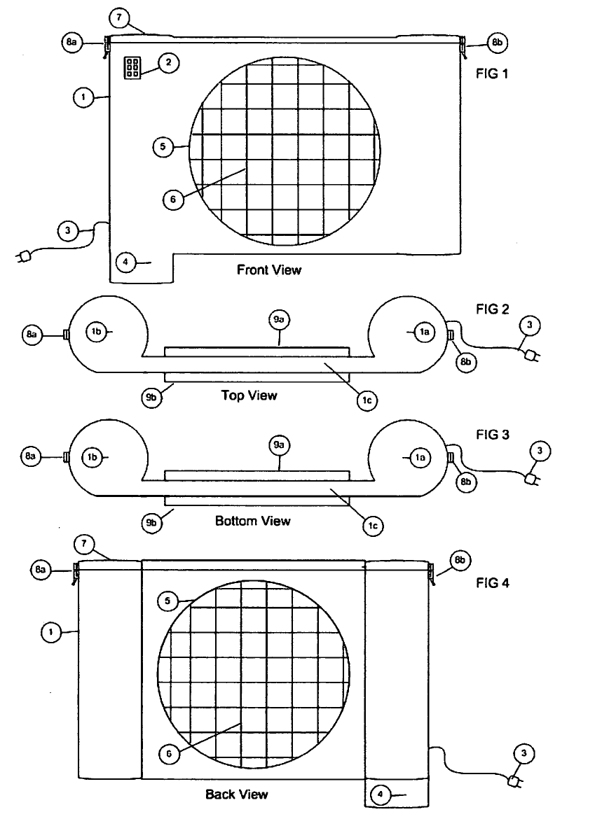

FIG. 1 illustrates the front view of the present invention. The invention comprises a filter housing 1 containing an opening 5, a drive-motor 4, a drive-motor control 2, and a lid 7 with latches 8a, 8b. The drive-motor 4 contains a power cord 3 to connect the drive-motor 4 to an electrical power source in a hard-wired configuration. The drive-motor control 2 connects to the drive-motor 4, and controls the drive-motor by regulating the electrical current supplied to the drive-motor 4. The drive-motor control 2 includes a keypad and other devices (such as an LED display) necessary to support interface with a human. The drive-motor control 2 also contains embedded logic, and is programmable via the keypad. Using the keypad of the drive-motor control 2, a person can program the frequency (how often) and duration (how long) of electrical current supplied to the drive-motor 4. For example, the drive-motor control 2 could be programmed to supply electrical current to the drive-motor 4 for forty-five seconds every thirty days.

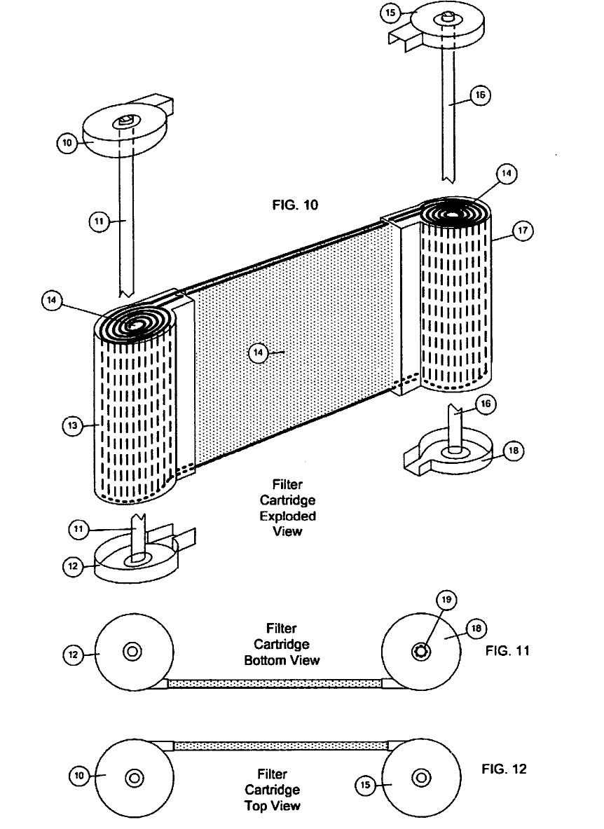

FIG. 2 and FIG. 3 illustrate the top (FIG. 2) and bottom (FIG. 3) views of the present invention, which make visible flanges 9a, 9b on both the front 9b and back 9a of the filter housing 1. These figures also illustrate the cylindrical ends 1a, 1b and rectangular mid-section 1c of the filter housing 1. The rectangular mid-section 1c of the housing 1 is dramatically narrower than the cylindrical ends 1a, 1b of the housing 1. The rectangular mid-section 1c of the housing 1 is joined tangentially to the cylindrical ends 1a, 1b of the housing 1. The flanges 9a, 9b are used to connect the filter housing 1 (FIG. 1) to the external devices used to supply air to and receive air from the filter assembly. The cylindrical ends 1a, 1b are designed to accommodate the left and right filter containers (to be described in FIGS. 10 through 16).

FIG. 4 illustrates the back view of the present invention in which the opening 5 of the filter housing 4 is covered by a grill 6 that is used to support filter material (to be described in FIGS. 10, 13, and 14). This figure, in combination with FIG. 1, makes obvious that the opening 5 passes through the entire filter assembly—meaning there is an opening on the front of the filter housing 1 in which air enters and an opening on the rear of the filter housing 1 in which air exits.

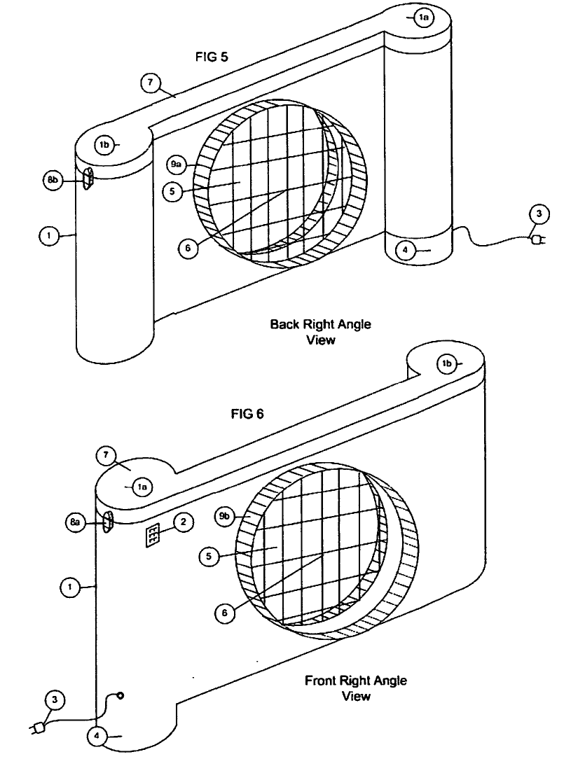

FIG. 5 illustrates the back, right angle view of the present invention and reveals more clearly the rear flange 9a and placement of the grill 6. The figure, as well as FIG. 1, FIG. 4, and FIG. 6, illustrate that the left cylindrical end of the filter housing 1 is longer than the right cylindrical end of the filter housing, in order to accommodate the drive-motor 4.

FIG. 6 illustrates the front, right angle view and reveals more clearly the front flange 9b and that the grill 6 placement is on one side of the housing 1 only. In this configuration, airflow is from front to rear meaning air enters the front of the housing 1 and exits the rear of the housing. Filter material (to be described in FIGS. 10, 13, and 14) lies over a grill 6, which supports the filter material. The filter material filters the air as the air passes through it before leaving the housing 1.

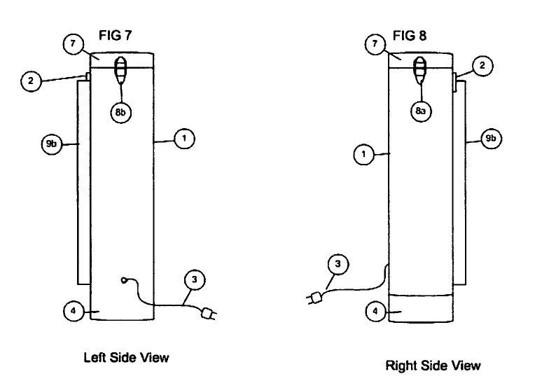

FIG. 7 and FIG. 8 illustrate the left (FIG. 7) and right (FIG. 8) views of the present invention, and display the location of the latches 8a, 8b used to fasten the lid 7 to the housing 1.

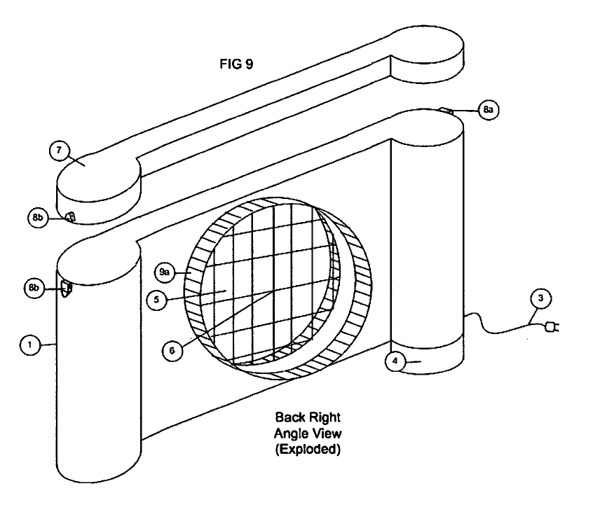

FIG. 9 illustrates the back, right angle exploded view of the present invention, showing the lid 7 orientation relative to the housing 1.

FIG. 10 illustrates the rear, right angle exploded view of the filter cartridge assembly. The filter cartridge assembly comprises left 17 and right 13 filter containers that are primarily cylindrical in shape. One of the containers houses clean, unused filter material and the other container collects used filter. Determination of which container houses clean filter material and which houses used filter material is based on the location of the drive-motor 4 (FIG. 1). In the present configuration, the drive-motor 4 (FIG. 1) is located on the left, and therefore, the left container of the filter cartridge stores used filter material.

The top and bottom of the left filter container 17 are enclosed by upper 15 and lower 18 lids. The upper 15 and lower 18 lids support an axle 16 that passes through the center of the left filter container 17. Filter material 14 is fed from the right filter container 13 into the left filter container 17 through the rectangular, vertical opening in the container and is affixed to the axle 16. The axle 16 rotates within the left filter container 17, and as it rotates, used filter material is wound upon the axle 16 and stored in the left filter 17.

The top and bottom of the right filter container 13 are enclosed by upper 10 and lower 12 lids. The upper 10 and lower 12 lids support an axle 11 that passes through the center of the right filter container 13. Clean filter material 14 is wound upon the axle 11 and is stored in the right filter container 13. The leading end of the filter material 14 is fed from the right filter container 13 to the left filter container 17 through the rectangular, vertical opening in the right filter container 13. The axle 11 rotates within the right filter container 13, and as it rotates, clean filter material is unwound from the axle 11.

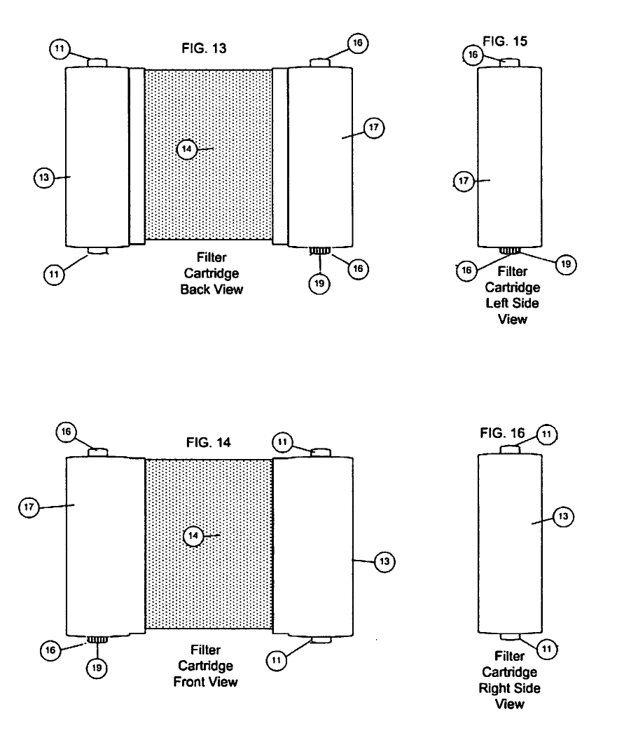

The lids 10, 12, 15, 18 are shown detached from the filter containers 13, 17 in this diagram for illustrative purpose only, and are intended to be affixed to the filter containers 13, 17 as shown in FIG. 13 and FIG. 14.

FIG. 11 illustrates the bottom, rear view of the filter cartridge and reveals a gear 19 attached to the base of the axle 16 (FIG. 10) that passes through the center of the left filter container 17 (FIG. 10). This gear 19 is designed to work with the drive-motor 4 (FIG. 1) in a manner such that when the drive-motor 4 (FIG. 1) rotates, the axle 16 (FIG. 10) also rotates causing clean filter material to be released from the right filter container 13 (FIG. 10) and used filter material to be collected in the left filter container 17 (FIG. 10). The figure also reveals the location of the left lower lid 18 and right lower lid 12 in relation to the rest of the filter cartridge.

FIG. 12 illustrates the top, rear view of the filter cartridge, revealing the location of the left upper lid 15 and right upper lid 10 in relation to the rest of the filter cartridge.

FIG. 13 illustrates the rear view of the filter cartridge. An axle 11 is mounted vertically through the center of the right filter container 13. An axle 16 containing a gear 19 at its base is mounted vertically through the center of the left filter container 17. A span of filter material 14 is exposed between the left filter container 17 and right filter container 13. The filter material 14 is affixed to both the axle 16 in the right filter container and the axle 11 in the left filter container. The gear 19 at the base of the axle 16 mounted in the left filter container 17 is designed to work with the drive-motor 4 (FIG. 1). As the drive-motor 4 (FIG. 1) rotates, the axle 16 in the left filter container 17 also rotates as a result of its connection to the drive-motor 4 (FIG. 1) via the gear 19. The rotation of the axle 16 in the left filter container 17 causes the filter material 14 to be wound upon the axle 16 and simultaneously causes the filter material 14 wound upon the axle 11 in the right filter container 13 to unwind.

FIG. 14 illustrates the front view of the filter cartridge. An axle 11 is mounted vertically through the center of the right filter container 13. An axle 16 containing a gear 19 at its base is mounted vertically through the center of the left filter container 17. A span of filter material 14 is exposed between the left filter container 17 and right filter container 13. The filter material 14 is affixed to both the axle 16 in the right filter container and the axle 11 in the left filter container. The gear 19 at the base of the axle 16 mounted in the left filter container 17 is designed to work with the drive-motor 4 (FIG. 1). As the drive-motor 4 (FIG. 1) rotates, the axle 16 in the left filter container 17 also rotates as a result of its connection to the drive-motor 4 (FIG. 1) via the gear 19. The rotation of the axle 16 in the left filter container 17 causes the filter material 14 to be wound upon the axle 16 and simultaneously causes the filter material 14 wound upon the axle 11 in the right filter container 13 to unwind.

FIG. 15 illustrates the left, side view of the filter cartridge. A gear 19 is shown at the base of an axle 16 that passes through the center of the left filter container 17.

FIG. 16 illustrates the right, side view of the filter cartridge. An axle 11 passes through the center of the right filter container 13.

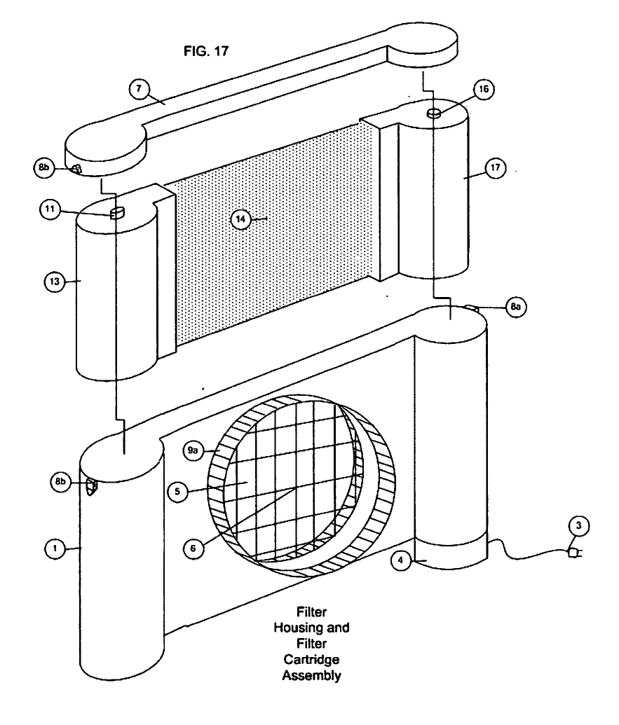

FIG. 17 illustrates the positioning of the filter cartridge (defined in FIGS. 10 through 16) in relation to the filter housing (described in FIGS. 1 through 9). The filter cartridge is designed to fit inside the filter housing 1 with a length of filter 14 covering the opening 5 in the filter housing 1. Unfiltered air enters the filter housing 1 through the opening 5 in the rear of the filter housing, passes through the filter 14 which fits between the front and rear walls of the filter housing and is supported by a grate 6, and exits, filtered, through the opening in the front of the filter housing 1. The lid 7 encloses the top of the filter housing 1 after the filter cartridge is installed, and is secured by a left 8a and right 8b latch. The HVAC system's air-return duct supplies the air that is to be filtered, and the duct is affixed to the flange 9a on the rear of the filter housing 1.

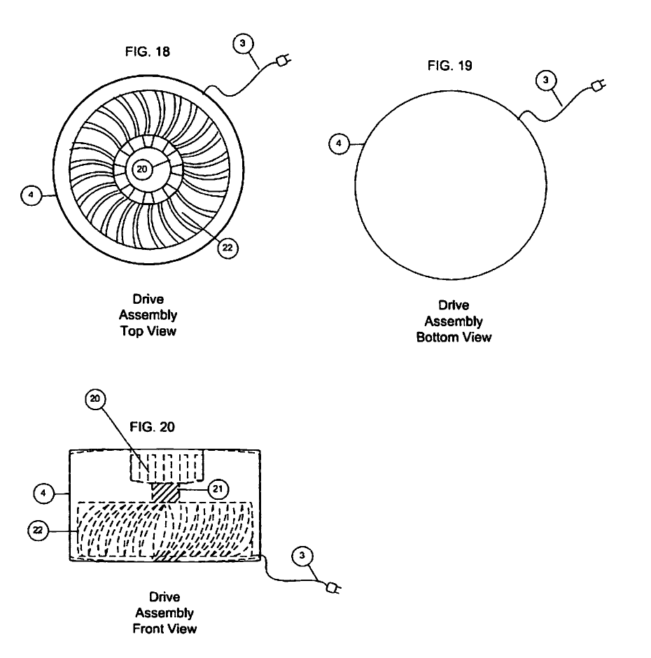

FIG. 18 illustrates the top view of the drive-motor 4. The drive-motor 4 consists of an electric motor 22 with a drive shaft that has a gear 20 affixed to it. The drive-motor 4 may be battery powered or hard-wired. FIG. 18 assumes a hard-wired configuration, and reveals a power cord 3 that would connect the drive-motor 4 to a buildings electrical service.

FIG. 19 illustrates the bottom view of the drive-motor.

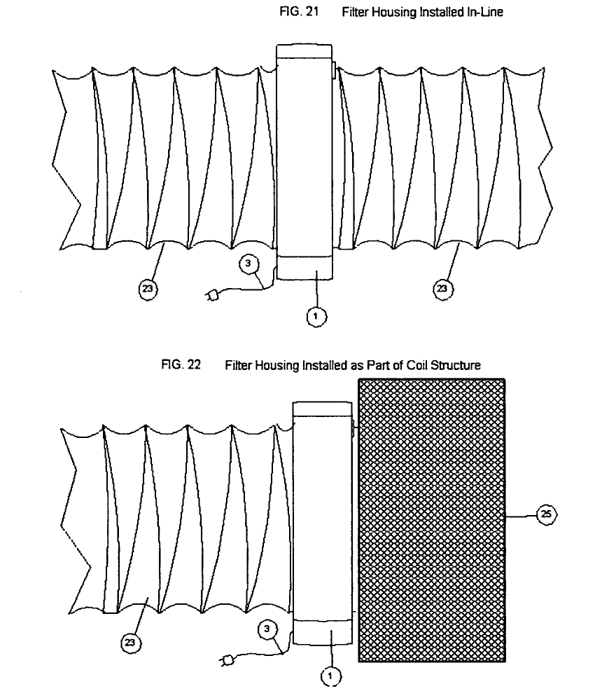

FIG. 20 illustrates a front, cross-sectional view of the drive-motor 4. The illustration reveals the position of the drive shaft 21, gear 20, and motor windings 22. The drive-motor 4 is affixed to the base of the left cylindrical end 1b (FIG. 3) of the filter housing 1 (FIG. 1). The gear 20 is designed to work with the gear 19 (FIG. 13) on the base of the left axle 16 (FIG. 13) of the filter cartridge. When electrical current is supplied to the motor, the motor rotates causing the drive shaft 21 to rotate. The drive shaft 21 is connected to the gear 20, causing the gear 20 to rotate. The gear is designed to work with the gear 19 (FIG. 13) on the base of the left axle 16 (FIG. 13) of the filter cartridge thus causing the axle 16 (FIG. 13) to rotate.

FIG. 21 illustrates the left, side view of the entire filter housing 1 connected to the air return duct 23 of an HVAC system. In this installation configuration, the air return duct 23 is spliced and the filter housing 1 is inserted between the two halves of the duct 23. The duct 23 is connected to the front 9b (FIG. 6) and rear 9a (FIG. 5) flanges of the filter housing. Air flowing through the air return duct 23 of the HVAC system is forced to pass through the filter material 14 (FIG. 17) contained within the filter housing thus filtering the air as it flows from the building/structure to the HVAC heating/cooling coils.

FIG. 22 illustrates an alternative installation configuration in which one side of the filter housing 1 is connected directly to the HVAC heating/cooling coils 25 and the other side is connected to the air return duct 23 of the HVAC system. Air flowing through the air return duct 23 of the HVAC system is forced to pass through the filter material 14 (FIG. 17) contained within the filter housing 1, thus filtering the air as it flows from the building/structure to the HVAC heating/cooling coils.

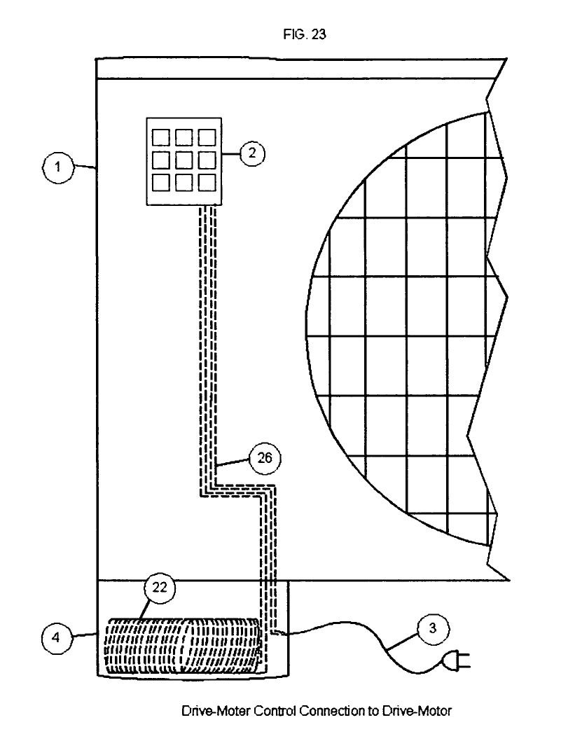

FIG. 23 illustrates the connection of the drive-motor control 2 to the drive-motor 4 via wiring 26. Electrical current first passes to the drive-motor control 2 before passing to the drive-motor 4. The drive-motor control unit 2 contains embedded logic, embodied in the appropriate hardware and software, which controls the timing (frequency and duration) of electrical current supplied to the drive-motor 4. When electrical current is supplied to the drive-motor 4, the windings 22 are energized causing the motor to rotate. The drive-motor control 2 supports human interface via a keypad and other devices (such as an LED display) as necessary to allow a human to program the timing (frequency and duration) of electrical current supplied to the drive-motor 4, ultimately controlling the timing of advancement of filter material 14 (FIG. 17).

I claim the following:

1. An automatic HVAC air-filter changing system comprising a) a filter housing having an opening through which air flows, b) a drive-motor that advances filter material, c) a drive-motor control unit used to program the frequency and length of filter material advancement, and d) a filter cartridge that fits into the filter housing and contains filter material where clean filter material is stored in a supply container and used filter material is stored in a collection container.

2. The filter housing defined in claim 1 embodies a drive-motor connected to a gear via a shaft (drive shaft)

3. The filter housing defined in claim 1 embodies a drive-motor control unit that a) contains embedded logic and b) supports human interface via a keypad and other devices (such as an LED display) as necessary to enable a person to program the unit.

4. The drive-motor control unit according to claim 3 is connected to the drive-motor and controls the drive-motor by regulating the electrical current supplied to the drive-motor.

5. The drive-motor control unit according to claim 3 contains programmable logic, embodied in the appropriate hardware and software, that is used to control the frequency and duration of electrical current supplied to the drive-motor (as defined in claim 1) by the drive-motor control unit.

6. The filter cartridge defined in claim 1 is of the appropriate size and shape to fit within cavity of the filter housing defined in claim 1.

7. The filter cartridge defined in claim 1 is an assembly comprising a) a continuous length of filter material, b) a supply container within which clean filter material is stored; and c) a collection container within which used filter material is stored.

8. The filter cartridge defined in claim 1 embodies a gear designed to function with the gear of the drive-motor described in claim 2 for the purpose of advancing the filter material contained within the filter cartridge defined in claim 6.
